(19) United States
(12) Patent Application Publication
(10) Pub. No.: US 2010/0048430 A1
(43) Pub. Date: Feb. 25, 2010

(54) Delayed crosslinking agents for high-temperature fracturing

(75) Inventors: Gary P. Funkhouser, Duncan, OK (US); David Loveless, Duncan, OK (US)

Correspondence Address: ROBERT A. KENT, P.O. BOX 1431, DUNCAN, OK, 73536, US

(73) Assignee: Halliburton Energy Services, Inc.

(21) Appl. No.: 12/229,176

(22) Filed: Aug. 19, 2008

(51) Int. Cl. C09K 8/60

(52) U.S. Cl. 507/219

(57) ABSTRACT

Treatment fluids comprising gelling agents and high-temperature, delayed crosslinkers, and methods of use in subterranean operations, are provided. In one embodiment, a method of treating a subterranean formation includes providing a treatment fluid comprising an aqueous base fluid; a gelling agent comprising terpolymer of 2-acrylamido-2-methylpropane sulfonic acid, acrylamide, and acrylic acid or a salt thereof; and a crosslinking agent comprising at least one component selected from the group consisting of zirconyl chloride and zirconium sulfate; and introducing the treatment fluid into a subterranean formation.

### BACKGROUND

The present invention relates to methods and compositions for treating subterranean formations. More particularly, the present invention relates to treatment fluids comprising gelling agents and delayed crosslinking agents, and methods of using these treatment fluids in high-temperature fracturing operations.

Treatment fluids may be used in a variety of subterranean treatments, including, but not limited to, stimulation treatments and sand control treatments. As used herein, the term “treatment,” or “treating,” refers to any subterranean operation that uses a fluid in conjunction with a desired function and/or for a desired purpose. The term “treatment,” or “treating,” does not imply any particular action by the fluid or any particular component thereof.

One common production stimulation operation that employs a treatment fluid is hydraulic fracturing. Hydraulic fracturing operations generally involve pumping a treatment fluid (e.g., a fracturing fluid) into a well bore that penetrates a subterranean formation at a sufficient hydraulic pressure to create or enhance one or more cracks, or “fractures,” in the subterranean formation. “Enhancing” one or more fractures in a subterranean formation, as that term is used herein, is defined to include the extension or enlargement of one or more natural or previously created fractures in the subterranean formation. The fracturing fluid may comprise particulates, often referred to as “proppant particulates,” that are deposited in the fractures. The proppant particulates function, inter alia, to prevent the fractures from fully closing upon the release of hydraulic pressure, forming conductive channels through which fluids may flow to the well bore. After at least one fracture is created and the proppant particulates are substantially in place, the fracturing fluid may be “broken” (i.e., the viscosity of the fluid is reduced), and the fracturing fluid may be recovered from the formation.

Treatment fluids are also utilized in sand control treatments, such as gravel packing. In gravel-packing treatments, a treatment fluid suspends particulates (commonly referred to as “gravel particulates”) to be deposited in a desired area in a well bore, e.g., near unconsolidated or weakly consolidated formation zones, to form a gravel pack to enhance sand control. One common type of gravel-packing operation involves placing a sand control screen in the well bore and packing the annulus between the screen and the well bore with the gravel particulates of a specific size designed to prevent the passage of formation sand. The gravel particulates act, inter alia, to prevent the formation particulates from occluding the screen or migrating with the produced hydrocarbons, and the screen acts, inter alia, to prevent the particulates from entering the production tubing. Once the gravel pack is substantially in place, the viscosity of the treatment fluid may be reduced to allow it to be recovered. In some situations, fracturing and gravel-packing treatments are combined into a single treatment (commonly referred to as “frac pack” operations). In such “frac pack” operations, the treatments are generally completed with a gravel pack screen assembly in place with the hydraulic fracturing treatment being pumped through the annular space between the casing and screen. In this situation, the hydraulic fracturing treatment ends in a screen-out condition, creating an annular gravel pack between the screen and casing. In other cases, the fracturing treatment may be performed prior to installing the screen and placing a gravel pack.

Maintaining sufficient viscosity in these treatment fluids is important for a number of reasons. For example, maintaining sufficient viscosity is important in fracturing and sand control treatments for particulate transport and/or to create or enhance fracture width. Also, maintaining sufficient viscosity may be important to control and/or reduce fluid-loss into the formation. At the same time, it may also be desirable to maintain the viscosity of the treatment fluid in such a way that the viscosity also may be easily reduced at a particular time, inter alia, for subsequent recovery of the fluid from the formation.

To provide the desired viscosity, polymeric gelling agents commonly are added to the treatment fluids to form viscosified treatment fluids. The term “gelling agent” is defined herein to include any substance that is capable of increasing the viscosity of a fluid, for example, by forming a gel. Examples of commonly used polymeric gelling agents include, but are not limited to, guar gums and derivatives thereof, cellulose derivatives, biopolymers, and the like. To further increase the viscosity of a viscosified treatment fluid, often the gelling agent is crosslinked with the use of a crosslinking agent. Conventional crosslinking agents usually comprise a metal ion that interacts with at least two gelling agent molecules to form a crosslink between them, thereby forming a “crosslinked gelling agent.” In some instances, treatment fluids comprising crosslinked gelling agents also may exhibit elastic or viscoelastic properties, wherein the crosslinks between gelling agent molecules may be broken and reformed, allowing the viscosity of the fluid to vary with certain conditions such as temperature, pH, and the like.

In high temperature applications, however, some viscosified treatment fluids may degrade and lose viscosity, especially those that are aqueous-based and comprise biopolymer gelling agents. Accordingly, various viscosity-increasing synthetic polymers have been developed for use in aqueous treatment fluids that can be crosslinked to achieve high viscosity and subsequently broken. While such synthetic polymers have achieved some success, crosslinking these fluids may be problematic. For example, in some instances, the gelling agent may “over-crosslink” in the presence of high concentrations of crosslinking agent, yielding a treatment fluid that is over-viscosified, difficult to break, exhibits syneresis (i.e., separation of liquid in a gel), or has other undesirable rheological properties. In addition, in some instances, the gelling agent may crosslink too rapidly, often before introduction into the subterranean formation, resulting in high friction pressure and gel shear degradation inside the tubing used to introduce the treatment fluid into the subterranean formation.

### SUMMARY

The present invention relates to methods and compositions for treating subterranean formations. More particularly, the present invention relates to treatment fluids comprising gelling agents and delayed crosslinking agents, and methods of using these treatment fluids in high-temperature fracturing operations.

In one embodiment of the present invention, a method of treating a subterranean formation comprises providing a treatment fluid comprising an aqueous base fluid; a gelling agent comprising terpolymer of 2-acrylamido-2-methylpropane sulfonic acid, acrylamide, and acrylic acid or a salt thereof; and a crosslinking agent comprising at least one component selected from the group consisting of zirconyl chloride and zirconium sulfate; and introducing the treatment fluid into a subterranean formation.

In another embodiment of the present invention, a method of fracturing a subterranean formation comprises providing a treatment fluid comprising an aqueous base fluid; a gelling agent comprising terpolymer of 2-acrylamido-2-methylpropane sulfonic acid, acrylamide, and acrylic acid or a salt thereof; and a crosslinking agent comprising at least one component selected from the group consisting of zirconyl chloride and zirconium sulfate; and introducing the treatment fluid into a subterranean formation at a pressure sufficient to create or enhance at least one fracture within the subterranean formation.

In yet another embodiment of the present invention, a treatment fluid comprises an aqueous base fluid; gelling agent comprising a terpolymer of 2-acrylamido-2-methylpropane sulfonic acid, acrylamide, and acrylic acid or a salt thereof; and a crosslinking agent comprising at least one component selected from the group consisting of zirconyl chloride and zirconium sulfate.

The features and advantages of the present invention will be readily apparent to those skilled in the art. While numerous changes may be made by those skilled in the art, such changes are within the spirit of the invention.

### BRIEF DESCRIPTION OF THE DRAWINGS

These drawings illustrate certain aspects of some of the embodiments of the present invention and should not be used to limit or define the invention.

FIG. 1 illustrates the viscoelastic properties of a treatment fluid in accordance with a particular embodiment of the present invention;

FIG. 2 illustrates the effect of acetate and lactate on the crosslinking onset temperature of treatment fluids in accordance with some embodiments of the present invention; and

FIG. 3 illustrates the effect of varying the ratio of different crosslinking agents present in a treatment fluid on the crosslinking onset temperature for the fluid in accordance with some embodiments of the present invention.

### DESCRIPTION OF PREFERRED EMBODIMENTS

The present invention relates to methods and compositions for treating subterranean formations. More particularly, the present invention relates to treatment fluids comprising gelling agents and delayed crosslinking agents, and methods of using these treatment fluids in high-temperature fracturing operations.

One of the advantages of some embodiments of the present invention, many of which are not discussed herein, is the ability to treat subterranean formations having temperatures as high as 400° F. without the treatment fluids becoming substantially unstable. Another potential advantage associated with some embodiments of the present invention may include the ability to delay the crosslinking of the treatment fluid until after the fluid has been introduced into a subterranean formation. Such a delay may help to avoid high friction pressure and gel shear degradation prior to introduction into the formation. Yet another potential advantage of some embodiments of the present invention may include the ability to tailor the activation temperature for the crosslinking reaction by the addition of one or more crosslinking delaying agents. Other advantages may be evident to one skilled in the art.

Before the crosslinking reaction occurs, the treatment fluids of the present invention may comprise an aqueous base fluid; a gelling agent comprising a terpolymer of 2-acrylamido-2-methylpropane sulfonic acid, acrylamide, and acrylic acid or a salt thereof, and a crosslinking agent comprising at least one component selected from the group consisting of zirconyl chloride and zirconium sulfate. After the crosslinking reaction occurs, a treatment fluid in accordance with the present invention may comprise an aqueous base fluid and a reaction product of a gelling agent comprising a terpolymer of 2-acrylamido-2-methylpropane sulfonic acid, acrylamide, and acrylic acid or a salt thereof and a crosslinking agent comprising at least one component selected from the group consisting of zirconyl chloride and zirconium sulfate.

Optionally, in some embodiments, the crosslinking agent may also comprise a crosslinking delaying agent to further delay the crosslinking reaction until a desired time and a stabilizing agent operable to provide sufficient stability to allow the crosslinking agent to be uniformly mixed into the polymer solution. Additionally, other additives may be present in a treatment fluid as needed for a chosen application, including but not limited to internal delayed gel breakers, gel stabilizers, and pH-adjusting agents.

Generally, the aqueous base fluids used in the treatment fluids of the present invention may comprise fresh water, saltwater (e.g., water containing one or more salts dissolved therein), brine (e.g., saturated saltwater), seawater, or combinations thereof, and may be from any source, provided that they do not contain components that might adversely affect the stability and/or performance of the treatment fluids of the present invention. In some embodiments, the density of the aqueous base fluid may be increased, among other purposes, to provide additional particle transport and suspension in the treatment fluids of the present invention. Additionally, in some embodiments, the pH of the aqueous base fluid may be adjusted (e.g., by a buffer or other pH adjusting agent), among other purposes, to facilitate hydration of the gelling agent, activate a crosslinking agent, and/or reduce the viscosity of the treatment fluid (e.g., activate a breaker, deactivate a crosslinking agent). In these embodiments, the pH may be adjusted to a specific level, which may depend on, among other factors, the type of gelling agent, type of crosslinking agent, and/or type of gel breaker (if present) included in the treatment fluid. With the benefit of this disclosure, one of ordinary skill in the art will recognize when such density and/or pH adjustments are appropriate.

Treatment fluids of the present invention also comprise a gelling agent including one or more synthetic polymers containing carboxylate groups. In some embodiments, the synthetic polymer comprises a terpolymer of 2-acrylamido-2-methylpropane sulfonic acid (hereinafter referred to as “AMPS®”), acrylamide, and acrylic acid or salts thereof. As used herein, the term “terpolymer” refers to a polymer that results from the copolymerization of three discrete monomers, while the term “polymer” refers to a chemical compound formed by polymerization and consisting essentially of repeating structural units. The terpolymer of AMPS®, acrylamide, and acrylic acid or salts thereof is believed to hydrate in the presence of water to form a gel that can be rapidly cross-linked by metal ions. Generally, the AMPS® is present in the terpolymer in an amount in the range of from about 15 weight % to about 80 weight %, the acrylamide is present therein in an amount in the range of from about 20 weight % to about 85 weight %, and the acrylic acid (or salts thereof) is present therein in an amount in the range of from about 0 weight % to about 10 weight %. In some embodiments, the terpolymer may comprise about 55 to about 65 weight % AMPS®, about 34.5 to about 44.5 weight % acrylamide, and about 0.1 to about 1.0 weight % acrylic acid or salts thereof. In some embodiments, the terpolymer may comprise about 60 weight % AMPS®, about 39.5 weight % acrylamide, and about 0.5 weight % acrylic acid or salts thereof.

Generally, the gelling agent is present in the treatment fluids of the present invention in an amount sufficient to provide the desired viscosity. For example, the gelling agent may be present in the treatment fluid in an amount in the range of from about 0.05% to about 2% weight/volume. In some embodiments, the synthetic polymer may be present in an amount in the range of from about 0.1% to about 1% weight/volume.

The treatment fluids of the present invention also include at least one crosslinking agent to crosslink at least a portion of the molecules of the polymer to form a crosslinked polymer. As used herein, the term “crosslinking agent” includes any molecule, atom, or ion that is capable of forming one or more crosslinks between molecules of the crosslinkable polymer and/or between two or more atoms in a single molecule of the crosslinkable polymer. The term “crosslink” as used herein refers to a covalent or ionic bond that links one polymer chain to another.

Generally, the crosslinking agent is present in the treatment fluid in an amount sufficient to provide, inter alia, the desired degree of crosslinking between molecules of the crosslinkable polymers. In some embodiments, the crosslinking agent may comprise a delayed crosslinking agent, which may be formulated to form crosslinks between polymer molecules after a certain time or under certain conditions (e.g., temperature, pH, etc.).

The crosslinking agent in the treatment fluids of the present invention may comprise a metal ion that is capable of crosslinking at least two molecules of the crosslinkable polymer. Examples of suitable metal ions include, but are not limited to, zirconium IV ions. These ions may be provided by providing any compound that is capable of producing one or more of these ions; examples of such compounds include, but are not limited to, zirconyl chloride and zirconium sulfate. An example of one suitable commercially available compound capable of providing metal ions is the “CL-40™” crosslinker available from Halliburton Energy Services, Inc. of Duncan, Okla. When CL-40™ is used in guar-based treatment fluids, the resulting fluids generally exhibit low crosslinking onset temperatures. In contrast, when CL-40™ is used in the synthetic treatment fluids of the present invention, the resulting fluids generally exhibit higher crosslinking onset temperatures, in some embodiments delaying the onset of crosslinking until the treatment fluids have been introduced into a subterranean formation.

In some embodiments, the crosslinking agent is present in the treatment fluid in an amount from about 0.1 to about 1.0% by volume. In some embodiments, the crosslinking agent comprises about 0.3% by volume of the fluid. Considerations one may take into account in deciding how much crosslinking agent may be needed include the temperature conditions of a particular application, the composition of the gelling agent used, and/or the pH of the treatment fluid. Other considerations may be evident to one skilled in the art.

The crosslinking of the synthetic polymer is believed to occur through carboxylate groups on the polymer interacting with small clusters of hydrous zirconium oxide, such as dimers, tetramers, or higher oligomers. Furthermore, crosslinking is believed to be dependent on pH. In some embodiments, a pH in the range of 3 to 5 may be most desirable for maximizing the viscosity of the crosslinked fluid.

In some embodiments, the crosslinking agent may also comprise one or more crosslinking delaying agents to delay the crosslinking reaction relative to when the crosslinking reaction would have occurred in the absence of the crosslinking delaying agent. In some embodiments, this may comprise increasing the temperature at which the onset of crosslinking occurs. Examples of suitable crosslinking delaying agents include, but are not limited, to α-hydroxy acids, such as lactic acid, glycolic acid, and tartaric acid; and polyols, such as glycerin. In some embodiments, glycerin may provide the additional benefit of improving the stability of the gelling agent after it reaches its final, downhole temperature. Generally, these delaying agents may be present in the crosslinking agent in an amount up to about twice the amount on a molar basis of the metal ion present (e.g., zirconium).

The crosslinking agent may also comprise a stabilizing agent operable to provide sufficient stability to allow the crosslinking agent to be uniformly mixed into the polymer solution. Examples of suitable stabilizing agents include, but are not limited, to propionate, acetate, formate, triethanolamine, and triisopropanolamine. In some embodiments, stabilizing agents, such as triisopropanolamine, may improve the shelf life of crosslinking agents with high metal ion (e.g., zirconium) to delaying agent (e.g., lactate) ratios. In particular embodiments, the stabilizing agent may be present in the crosslinking agent in an amount up to about four times the amount on a molar basis of the metal ion present (e.g., zirconium).

In some embodiments, the crosslinking agent may be prepared by mixing two constituent crosslinking agents having different compositions to yield a crosslinking agent that exhibits a certain set of desired properties. For example, in some embodiments, a crosslinking agent with a high zirconium to lactate ratio may be mixed with a base crosslinking agent in varying ratios to adjust the crosslinking onset temperature over a wide range of temperatures. Such a combination may offer the advantage of requiring only two different compositions in product inventory to yield crosslinking agents suitable for a broad range of well conditions.

The treatment fluids of the present invention may also include internal delayed gel breakers such as enzyme, oxidizing, acid buffer, or temperature-activated gel breakers. The gel breakers may cause the viscous treatment fluids to revert to thin fluids that can be produced back to the surface after they have been used to place proppant particles in subterranean fractures. Examples of suitable gel breakers include, but are not limited to, manganese dioxide, sodium chlorate, and sodium bromate. In some embodiments, the gel breaker is present in the treatment fluid in an amount of about 0.25 to about 25 lb/1000 gal of fluid. In some embodiments, the gel breaker used may be present in the treatment fluid in an amount in the range of from about 0.25 to about 15 lb/1000 gal of fluid.

In some embodiments, the treatment fluids of the present invention may also include a gel stabilizer. Examples of suitable gel stabilizers include, but are not limited to, erythorbic acid, ascorbic acid, isoascorbic acid, and alkali metal salts thereof. In some embodiments, the gel stabilizer may be present in an amount in the range of about 0 to about 5 lb/1000 gal of fluid. In some embodiments, the gel stabilizer is present in an amount of about 2.5 lb/1000 gal of fluid.

In some embodiments, the treatment fluids of the present invention may also include a pH-adjusting agent. Examples of suitable pH-adjusting agents include, but are not limited to, sulfamic acid, hydrochloric acid, sulfuric acid, and sodium bisulfate. In some embodiments, the pH-adjusting agent may be selected so as not to compete with the gelling agent for metal ions provided by the crosslinking agent.

The treatment fluids of the present invention may also include one or more of a variety of well-known additives, such as fluid loss control additives, acids, corrosion inhibitors, catalysts, clay stabilizers, biocides, bactericides, friction reducers, gas, surfactants, solubilizers, and the like. In some embodiments, it may be desired to foam a treatment fluid of the present invention using a gas, such as air, nitrogen, or carbon dioxide. Those of ordinary skill in the art, with the benefit of this disclosure, will be able to determine the appropriate additives for a particular application.

The treatment fluids of the present invention optionally may comprise particulates, such as proppant particulates or gravel particulates. Particulates suitable for use in the present invention may comprise any material suitable for use in subterranean operations. Suitable materials for these particulates include, but are not limited to, sand, bauxite, ceramic materials, glass materials, polymer materials, Teflon® materials, nut shell pieces, cured resinous particulates comprising nut shell pieces, seed shell pieces, cured resinous particulates comprising seed shell pieces, fruit pit pieces, cured resinous particulates comprising fruit pit pieces, wood, composite particulates, and combinations thereof. Suitable composite particulates may comprise a binder and a filler material wherein suitable filler materials include silica, alumina, fumed carbon, carbon black, graphite, mica, titanium dioxide, meta-silicate, calcium silicate, kaolin, talc, zirconia, boron, fly ash, hollow glass microspheres, solid glass, and combinations thereof. The particulate size generally may range from about 2 mesh to about 400 mesh on the U.S. Sieve Series; however, in certain circumstances, other sizes may be desired and will be entirely suitable for practice of the present invention. In some embodiments, preferred particulates size distribution ranges are one or more of 6/12, 8/16, 12/20, 16/30, 20/40, 30/50, 40/60, 40/70, or 50/70 mesh. It should be understood that the term “particulate,” as used in this disclosure, includes all known shapes of materials, including substantially spherical materials, fibrous materials, polygonal materials (such as cubic materials), and mixtures thereof. Moreover, fibrous materials, that may or may not be used to bear the pressure of a closed fracture, may be included in certain embodiments of the present invention. In certain embodiments, the particulates included in the treatment fluids of the present invention may be coated with any suitable resin or tackifying agent known to those of ordinary skill in the art. In certain embodiments, the particulates may be present in the treatment fluids of the present invention in an amount in the range of from about 0.5 to about 30 lb/gal of the treatment fluid.

The treatment fluids of the present invention may be prepared by any method suitable for a given application. For example, certain components of the treatment fluid of the present invention may be provided in a pre-blended powder or a dispersion of powder in a nonaqueous liquid, which may be combined with the aqueous base fluid at a subsequent time. In preparing the treatment fluids of the present invention, the pH of the aqueous base fluid may be adjusted, among other purposes, to facilitate the hydration of the gelling agent. The pH range in which the gelling agent will readily hydrate may depend upon a variety of factors (e.g., the components of the gelling agent, etc.) that will be recognized by one skilled in the art. This adjustment of pH may occur prior to, during, or subsequent to the addition of the gelling agent and/or other components of the treatment fluids of the present invention. After the preblended powders and the aqueous base fluid have been combined crosslinking agents and other suitable additives may be added prior to introduction into the well bore. Those of ordinary skill in the art, with the benefit of this disclosure will be able to determine other suitable methods for the preparation of the treatments fluids of the present invention.

The methods of the present invention may be employed in any subterranean treatment where a viscoelastic treatment fluid may be used. Suitable subterranean treatments may include, but are not limited to, fracturing treatments, sand control treatments (e.g., gravel packing), and other suitable treatments where a treatment fluid of the present invention may be suitable. In one embodiment, the present invention provides a method of treating a portion of a subterranean formation comprising providing a treatment fluid comprising an aqueous base fluid; a gelling agent comprising a terpolymer of 2-acrylamido-2-methylpropane sulfonic acid, acrylamide, and acrylic acid or a salt thereof; and a crosslinking agent comprising at least one component selected from the group consisting of zirconyl chloride and zirconium sulfate; and introducing the treatment fluid into a subterranean formation. In another embodiment, the present invention provides a method of fracturing a subterranean formation comprising providing a treatment fluid comprising an aqueous base fluid; a gelling agent comprising terpolymer of 2-acrylamido-2-methylpropane sulfonic acid, acrylamide, and acrylic acid or a salt thereof; and a crosslinking agent comprising at least one component selected from the group consisting of zirconyl chloride and zirconium sulfate; and introducing the treatment fluid into a subterranean formation at a pressure sufficient to create or enhance at least one fracture within the subterranean formation.

To facilitate a better understanding of the present invention, the following examples of specific embodiments are given. In no way should the following examples be read to limit or define the entire scope of the invention.

### Example 1

To illustrate the delayed crosslinking of treatment fluids in accordance with an embodiment of the present invention, a sample treatment fluid was prepared using a liquid dispersion polymer comprising a 50% w/w dispersion of dry polymer in oil. The polymer composition comprised 60% w/w sodium 2-acrylamido-2-methylpropanesulfonate, 39.5% w/w acrylamide, and 0.5% w/w sodium acrylate. A 350 ml blender jar was charged with 147.50 g of tap water. While shearing at moderate speed, 2.50 ml of the liquid dispersion polymer was added, followed by 0.50 ml 15% w/v sulfamic acid, 45 mg of Ferchek® (an oxygen scavenger commercially available from Halliburton Energy Services, Inc. of Duncan, Okla.), and 0.45 ml CL-40™.

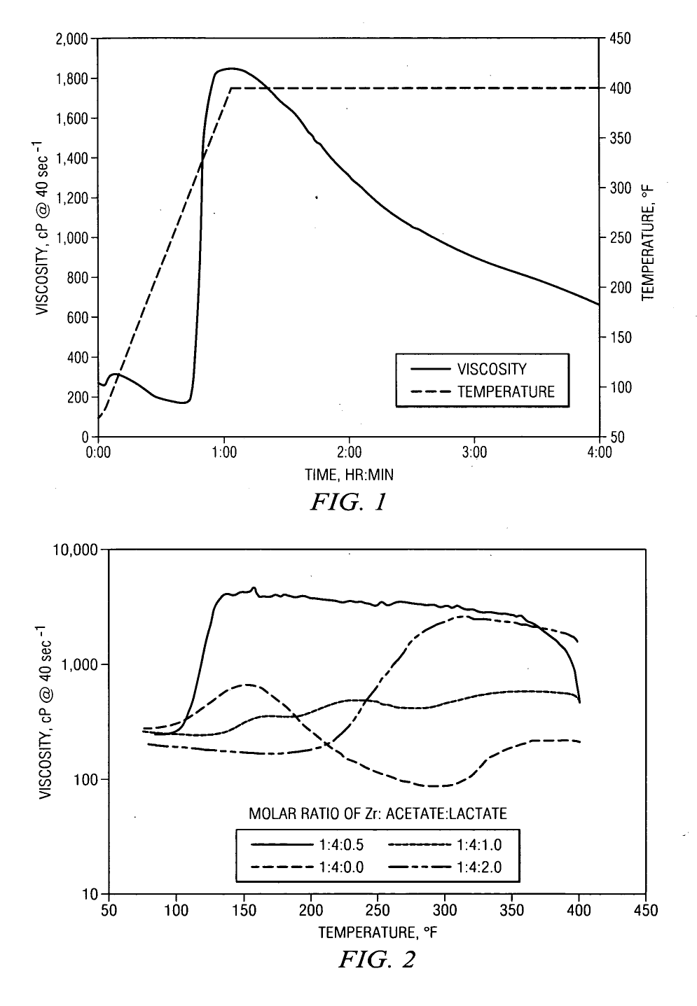

The resulting mixture was sheared for 15 seconds at a speed sufficient to maintain a vortex. Afterwards, the viscosity of the mixture was measured using a Chandler 5550 viscometer fitted with a B5X bob and R1 rotor while the temperature was steadily increased to 400° F. over one hour, and then maintained at 400° F. for three hours. During this time, the sample was subjected to a constant shear rate of 40 sec⁻¹. The resulting plots of viscosity and temperature versus time are illustrated in FIG. 1.

As shown in FIG. 1, at approximately 300° F., the viscosity of the sample treatment fluid increased from approximately 200 cP to approximately 1,850 cP, indicating the onset of crosslinking. After an extended time at 400° F., the viscosity of the fluid began to decrease, but after three hours at 400° F., the viscosity of the fluid still remained above 600 cP, approximately three times the viscosity of the pre-crosslinked fluid.

### Example 2

To illustrate the affect of lactate and acetate on the crosslinking onset temperature of treatment fluids in accordance with an embodiment of the present invention, five sample treatment fluids were prepared using the same liquid dispersion polymer in Example 1. For each sample, a 350 ml blender jar was charged with 147.75 g of tap water. While shearing at moderate speed 2.25 ml of the liquid dispersion polymer was added, followed by 0.45 ml of 15% w/v sulfamic acid and 45 mg of Ferchek®.

To each of these samples, 0.75 ml of a different crosslinking agent was added. The compositions of these different crosslinking agents are listed in the table below.

TABLE 1

| Crosslinking Agent | Zr:Acetate:Lactate | 30% | Ammonium | 80% Lactic | 15% |
|---|---|---|---|---|---|
| No. | Molar Ratio | ZrOCl₂ | Acetate | Acid | Ammonia |
| 1 | 1:4:0 | 10 g | 5.20 g | 0 | none |
| 2 | 1:4:0.5 | 10 g | 5.26 g | 1.00 g | to pH 7 |
| 3 | 1:4:1 | 10 g | 5.22 g | 2.01 g | none |
| 4 | 1:4:2 | 10 g | 5.20 g | 3.80 g | none |

The resulting mixtures were sheared for 15 seconds at a speed sufficient to maintain a vortex. Afterwards, the viscosities of the mixtures were measured using a Chandler 5550 viscometer fitted with a B5X bob and R1 rotor while the temperature was steadily increased to 400° F. over 40 minutes. During this time, the samples were subjected to a constant shear rate of 40 sec⁻¹. The resulting plots of viscosity versus temperature are illustrated in FIG. 2.

As shown in FIG. 2, Sample no. 1, which contained no lactate, exhibited a crosslinking onset temperature of approximately 90° F. Sample no. 2, which had a zirconium-to-lactate molar ratio of 1:0.5, exhibited a crosslinking onset temperature of approximately 10° F. Sample no. 3, which had a zirconium-to-lactate molar ratio of 1:1, exhibited a crosslinking onset temperature of approximately 140° F. Lastly, sample no. 4, which had a zirconium-to-lactate molar ratio of 1:2, exhibited a crosslinking onset temperature of approximately 225° F. Accordingly, by increasing the molar ratio of lactate to zirconium in the fluid from 0:1 to 2:1, the crosslinking onset temperature was increased from approximately 90° F. to approximately 225° F. These experimental results also illustrate that acetate, which may provide sufficient stability to allow the crosslinking agent to be uniformly mixed in the polymer solution, does not significantly affect the onset of crosslinking.

### Example 3

To illustrate the effect of mixing crosslinking agents to control the crosslinking onset temperature of treatment fluids in accordance with an embodiment of the present invention, five sample treatment fluids were prepared using the same liquid dispersion polymer as in Example 1. For each sample, a 350 ml blender jar was charged with 147.75 g of tap water. While shearing at moderate speed, 2.25 ml of the liquid dispersion polymer was added, followed by 0.45 ml of 15% w/v sulfamic acid and 45 mg of Ferchek®. An activator solution was prepared by mixing 5 g of crosslinking agent no. 2 from Example 2 above with 0.51 g of triisopropanolamine. Five different crosslinking agents were prepared by mixing the activator solution and CL-40™ in different ratios and adding the resulting crosslinking agents to the samples as shown in the Table 2 below.

TABLE 2

| | | Volume of |
|---|---|---|
| | Ratio (by weight) of | crosslinking agent |
| Sample No. | activator to CL-40 ™ | added to fluid (ml) |
| 1 | 1:0 | 0.75 |
| 2 | 2:1 | 0.75 |
| 3 | 1:1 | 0.75 |
| 4 | 1:2 | 0.75 |
| 5 | 0:1 | 0.45 |

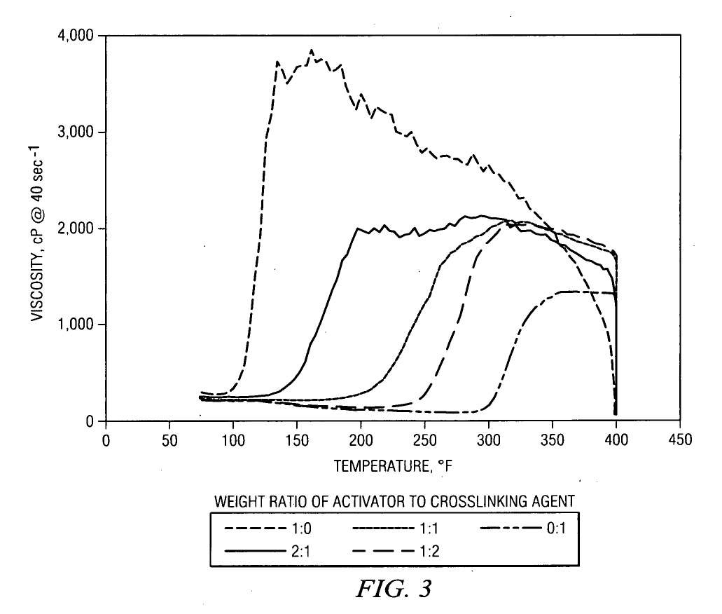

The resulting mixtures were sheared for 15 seconds at a speed sufficient to maintain a vortex. Afterwards, the viscosities of the mixtures were measured using a Chandler 5550 viscometer fitted with a B5X bob and R1 rotor while the temperature was steadily increased to 400° F. over 40 minutes. During this time, the samples were subjected to a constant shear rate of 40 sec⁻¹. The resulting plots of viscosity versus temperature are illustrated in FIG. 3.

As shown in FIG. 3, sample no. 1, comprising activator without any CL-40™, exhibited a crosslinking onset temperature of approximately 100° F.; sample no. 2, comprising a 2:1 weight ratio of activator to CL-40™, exhibited a crosslinking onset temperature of approximately 140° F.; sample no. 3, comprising a 1:1 weight ratio of activator to CL-40™, exhibited a crosslinking onset temperature of approximately 210° F.; sample no. 4, comprising a 1:2 weight ratio of activator to CL-40™, exhibited a crosslinking onset temperature of approximately 250° F.; and sample no. 5, comprising CL-40™ without any activator, exhibited a crosslinking onset temperature of approximately 300° F. Accordingly, these experimental results illustrate the ability to achieve a range of crosslinking onset temperatures by varying the amounts of the two constituent crosslinking agents in the treatment fluid.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. While numerous changes may be made by those skilled in the art, such changes are encompassed within the spirit of this invention as defined by the appended claims. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. In particular, every range of values (e.g., “from about a to about b,” or, equivalently, “from approximately a to b,” or, equivalently, “from approximately a-b”) disclosed herein is to be understood as referring to the power set (the set of all subsets) of the respective range of values. The terms in the claims have their plain, ordinary meaning unless otherwise explicitly and clearly defined by the patentee.

What is claimed is:

1. A treatment fluid comprising:
an aqueous base fluid;
gelling agent comprising a terpolymer of 2-acrylamido-2-methylpropane sulfonic acid, acrylamide, and acrylic acid or a salt thereof; and
a crosslinking agent comprising at least one component selected from the group consisting of zirconyl chloride and zirconium sulfate.

2. The treatment fluid of claim 1, wherein the 2-acrylamido-2-methylpropane sulfonic acid is present in the terpolymer in an amount of about 55% to about 65% by weight, the acrylamide is present in the terpolymer in an amount of about 34.5% to about 44.5% by weight, and the acrylic acid or salt thereof is present in the terpolymer in an amount of about 0.1% to about 1.0% by weight.

3. The treatment fluid of claim 1, wherein the crosslinking agent further comprises a crosslinking delaying agent selected from the group consisting of lactic acid, glycerin, glycolic acid, and tartaric acid.

4. The treatment fluid of claim 1, wherein the crosslinking agent further comprises a stabilizing agent selected from the group consisting of propionate, acetate, formate, triethanolamine and triisopropanolamine.

5. The treatment fluid of claim 1, further comprising a delayed gel breaker selected from the group consisting of manganese dioxide, sodium chlorate and sodium bromate.

6. The treatment fluid of claim 1, further comprising a gel stabilizer selected from the group consisting of erythorbic acid, ascorbic acid, isoascorbic acid, and alkali metal salts thereof.

7. A method of treating a subterranean formation, comprising:
providing a treatment fluid comprising an aqueous base fluid; a gelling agent comprising terpolymer of 2-acrylamido-2-methylpropane sulfonic acid, acrylamide, and acrylic acid or a salt thereof; and a crosslinking agent comprising at least one component selected from the group consisting of zirconyl chloride and zirconium sulfate; and
introducing the treatment fluid into a subterranean formation.

8. The method of claim 7, wherein the 2-acrylamido-2-methylpropane sulfonic acid is present in the terpolymer in an amount of about 55% to about 65% by weight, the acrylamide is present in the terpolymer in an amount of about 34.5% to about 44.5% by weight, and the acrylic acid or salt thereof is present in the terpolymer in an amount of about 0.1% to about 1.0% by weight.

9. The method of claim 7, wherein the crosslinking agent further comprises a crosslinking delaying agent selected from the group consisting of lactic acid, glycerin, glycolic acid, and tartaric acid.

10. The method of claim 7, wherein the crosslinking agent further comprises a stabilizing agent selected from the group consisting of propionate, acetate, formate, triethanolamine and triisopropanolamine.

11. The method of claim 7, wherein the treatment fluid further comprises a delayed gel breaker selected from the group consisting of manganese dioxide, sodium chlorate, and sodium bromate.

12. The method of claim 7, wherein the treatment fluid further comprises a gel stabilizer selected from the group consisting of erythorbic acid, ascorbic acid, isoascorbic acid, and alkali metal salts thereof.

13. The method of claim 7, wherein the treatment fluid further comprises a pH-adjusting agent selected from the group consisting of sulfamic acid, sulfuric acid, hydrochloric acid, and sodium bisulfate.

14. A method of fracturing a subterranean formation, comprising:
providing a treatment fluid comprising an aqueous base fluid; a gelling agent comprising terpolymer of 2-acrylamido-2-methylpropane sulfonic acid, acrylamide, and acrylic acid or a salt thereof; and a crosslinking agent comprising at least one component selected from the group consisting of zirconyl chloride and zirconium sulfate; and
introducing the treatment fluid into a subterranean formation at a pressure sufficient to create or enhance at least one fracture within the subterranean formation.

15. The method of claim 14, wherein the 2-acrylamido-2-methylpropane sulfonic acid is present in the terpolymer in an amount of about 55% to about 65% by weight, the acrylamide is present in the terpolymer in an amount of about 34.5% to about 44.5% by weight, and the acrylic acid or salt thereof is present in the terpolymer in an amount of about 0.1% to about 1.0% by weight.

16. The method of claim 14, wherein the crosslinking agent further comprises a crosslinking delaying agent selected from the group consisting of lactic acid, glycerin, glycolic acid, and tartaric acid.

17. The method of claim 14, wherein the crosslinking agent further comprises a stabilizing agent selected from the group consisting of propionate, acetate, formate, triethanolamine and triisopropanolamine.

18. The method of claim 14, wherein the treatment fluid further comprises a delayed gel breaker selected from the group consisting of manganese dioxide, sodium chlorate, and sodium bromate.

19. The method of claim 14, wherein the treatment fluid further comprises a gel stabilizer selected from the group consisting of erythorbic acid, ascorbic acid, isoascorbic acid, and alkali metal salts thereof.

20. The method of claim 14, wherein the treatment fluid further comprises a pH-adjusting agent selected from the group consisting of sulfamic acid, sulfuric acid, hydrochloric acid, and sodium bisulfate.
